(19) United States
(12) Patent Application Publication
(10) Pub. No.: US 2018/0043854 A1
(43) Pub. Date: Feb. 15, 2018

(54) GAS GENERATOR

(71) Applicant: Daicel Corporation, Osaka-shi, Osaka (JP)

(72) Inventors: Tomoharu KOBAYASHI, Tatsuno-shi (JP); Kenji FUKUMOTO, Tatsuno-shi (JP)

(73) Assignee: Daicel Corporation, Osaka-shi, Osaka (JP)

(21) Appl. No.: 15/559,732

(22) PCT Filed: Apr. 5, 2016
(86) PCT No.: PCT/JP2016/061116

§ 371 Date: Sep. 19, 2017

(30) Foreign Application Priority Data
Apr. 24, 2015 (JP) 2015-089423

(51) Int. Cl. B60R 21/264; B60R 21/261

(52) U.S. Cl. CPC B60R 21/264; B60R 21/261

(57) ABSTRACT

The present invention provides a gas generator including, in a cylindrical housing, a gas generation chamber accommodating a gas generating agent and an ignition device, the ignition device being disposed at a first end surface of the cylindrical housing, and a second end surface, which is axially opposite to the first end surface, being closed by a closing member, the closing member having a fragile portion formed such that a part thereof is ruptured when the first surface on the side of the gas generation chamber receives a pressure of a gas including a combustion gas, and the ruptured portion is bent and opened to the axially opposite side of the first surface, a gas discharge port for the combustion gas being formed by the ruptured portion which is bent and opened from a surface of a non-ruptured portion after the part of the closing member is ruptured along the fragile portion, a control device restricting an angle between the second surface of the closing member and the bent ruptured portion to be 5 degrees to 85 degrees, the control device being a member which is adjusted to have such a distance that the bent ruptured portion is in contact therewith, or a support portion which is formed to protrude from the second surface of the closing member at a position such as to be in contact with the ruptured portion.

### TECHNICAL FIELD

The present invention relates to a gas generator which is usable for an airbag apparatus of a vehicle or the like.

### DESCRIPTION OF RELATED ART

When a gas generating agent is loaded as a gas generating source of a gas generator, mist is generated by combustion of the gas generating agent. The mist is mainly molten metal components contained in the gas generating agent, and it is desirable that the mist is prevented, as much as possible, from being discharged to an outside of the gas generator.

U.S. Pat. No. 5,584,506 discloses an inflator 10 in which a plurality of cylindrical members are stacked in a radial direction to form a filter (FIGS. 2 and 3).

A combustion gas generated by combustion of gas generating disks 114 enters a first portion 250 of a filter chamber 140 from openings 68, and then enters a second portion 252 from inner openings 220. Thereafter, the combustion gas flows from outer openings 182 into a third portion 254, and then is discharged from gas outlet openings 58.

When the combustion gas enters the second portion 252 from the inner openings 220, the combustion gas collides with and bypasses an inner tab 200 and then enters the second portion 252. When the combustion gas enters the third portion 254 from the outer openings 182, the combustion gas collides with and bypasses an outer tab 180 and then enters the third portion 254. As a result of such repeated collision and bypassing, mist is easily captured.

The inner tab 200 and the outer tab 180 are kept inclined as shown in FIGS. 2 and 3 even before actuation, and they are not the ones which change to the state shown in FIGS. 2 and 3 at the time of actuation.

U.S. Pat. No. 6,142,515 discloses a gas generator having two combustion chambers. The inner combustion chamber is closed by a cap 260, and when the internal pressure rises at the time of actuation, the cap 260 is disengaged and the gas is discharged to an outside of the combustion chamber. Before actuation, the combustion chamber is closed by the cap 260, but once the combustion chamber is opened, the cap 260 is completely separated from the wall surface forming the combustion chamber, and the cap 260 may block a gas discharge path.

### SUMMARY OF INVENTION

The first aspect of the present invention (hereinafter, referred to as “the first aspect”) provides a gas generator including, in a cylindrical housing, a gas generation chamber accommodating a gas generating agent as a gas generating source and an ignition device,

the ignition device being disposed at a first end surface of the cylindrical housing, and a second end surface, which is axially opposite to the first end surface of the cylindrical housing, being closed by a closing member,

the closing member having a first surface on the side of the gas generation chamber and a second surface on the back side of the first surface,

the closing member having a fragile portion formed such that a part thereof is ruptured when the first surface receives a pressure of a gas including a combustion gas, and the ruptured portion is bent and opened to an axially opposite side of the first surface,

a gas discharge port for the combustion gas being formed by the ruptured portion which is bent and opened from a surface of a non-ruptured portion after the part of the closing member is ruptured along the fragile portion,

a control device restricting an angle between the second surface of the closing member and the bent ruptured portion to be 5 degrees to 85 degrees,

the control device being,
a member which is adjusted to have such a distance that the bent ruptured portion of the closing member is in contact therewith, or
a support portion which is formed to protrude from the second surface of the closing member at a position such as to be in contact with the bent ruptured portion.

The second aspect of the present invention (hereinafter, referred to as “the second aspect”) provides a gas generator including, in a cylindrical housing, a gas generation chamber accommodating a gas generating agent as a gas generating source, and a diffuser portion provided with a gas discharge port,

a closing member closing between the gas generation chamber and the diffuser portion,

the closing member having a first surface on the side of the gas generation chamber and a second surface on the back side of the first surface,

the closing member having a fragile portion formed such that a part thereof is ruptured when the first surface receives a gas pressure from the gas generating source, and the ruptured portion is bent and opened toward the diffuser portion,

a gas discharge path leading to a gas discharge port being opened by the ruptured portion which is bent and opened from a surface of a non-ruptured portion after the part of the closing member is ruptured along the fragile portion,

a control device restricting an angle between the second surface of the closing member and the bent ruptured portion to be 5 degrees to 85 degrees,

the control device being,
a wall surface of the diffuser portion which is adjusted to have such a distance that the bent ruptured portion of the closing member is in contact therewith, or
a support portion which is formed to protrude from the second surface of the closing member at a position such as to be in contact with the bent ruptured portion.

The third aspect of the present invention (hereinafter, referred to as “the third aspect”) provides a gas generator including, in a cylindrical housing, a gas generation chamber and a diffuser portion provided with a gas discharge port,

the gas generation chamber being a combination of a combustion chamber accommodating a gas generating agent and an ignition device, and a pressurized gas chamber filled with a gas,

the combustion chamber being arranged on the side of a first end surface of the cylindrical housing, the diffuser portion which is provided with the gas discharge port being arranged on the side of a second end surface which is axially opposite to the first end surface of the cylindrical housing, and the pressurized gas chamber being arranged between the combustion chamber and the diffuser portion,

a first closing member closing between the combustion chamber and the pressurized gas chamber, and a second closing member closing between the pressurized gas chamber and the diffuser portion,

the first closing member having a first surface on the side of the combustion chamber and a second surface on the back side of the first surface, which is on the side of the pressurized gas chamber,

the second closing member having a first surface on the side of the pressurized gas chamber and a second surface on the back side of the first surface, which is on the side of the diffuser portion,

the first closing member having a fragile portion formed such that a part thereof is ruptured when the first surface receives a combustion gas pressure generated in the combustion chamber, and the ruptured portion is bent and opened toward the pressurized gas chamber,

after the part of the first closing member is ruptured along the fragile portion, the ruptured portion being bent from a non-ruptured portion and opened so that a gas discharge path from the combustion chamber to the pressurized gas chamber is opened,

a control device restricting an angle between the second surface of the first closing member and the bent ruptured portion to be 5 degrees to 85 degrees,

the control device being a support portion which is formed to protrude from the second surface of the first closing member at a position such as to be in contact with the bent ruptured portion,

the second closing member having a fragile portion formed such that a part thereof is ruptured when the first surface receives a gas pressure of a combustion gas generated in the combustion chamber and a pressurized gas, and the ruptured portion is bent and opened toward the diffuser portion,

after the part of the second closing member is ruptured along the fragile portion, the ruptured portion being bent from a non-ruptured portion and opened so that a gas discharge path from the pressurized gas chamber to the diffuser portion is opened,

a control device restricting an angle between the second surface of the second closing member and the bent ruptured portion to be 5 degrees to 85 degrees,

the control device being,
a wall surface of the diffuser portion which is adjusted to have such a distance that the bent ruptured portion of the second closing member is in contact therewith, or
a support portion which is formed to protrude from the second surface of the second closing member at a position such as to be in contact with the bent ruptured portion.

The forth aspect of the present invention (hereinafter, referred to as “the forth aspect”) provides a gas generator including, in a cylindrical housing, a gas generation chamber and a diffuser portion provided with a gas discharge port,

the gas generation chamber being a combination of a combustion chamber accommodating a gas generating agent and an ignition device, and a pressurized gas chamber filled with a gas,

the combustion chamber being arranged on the side of a first end surface of the cylindrical housing, the pressurized gas chamber being arranged on the side of a second end surface which is axially opposite to the first end surface of the cylindrical housing, and the diffuser portion being arranged between the combustion chamber and the pressurized gas chamber,

a first closing member closing between the combustion chamber and the diffuser portion, and a second closing member closing between the diffuser portion and the pressurized gas chamber,

the first closing member having a first surface on the side of the combustion chamber and a second surface on the back side of the first surface, which is on the side of the diffuser portion,

the first closing member having a fragile portion formed such that a part thereof is ruptured when the first surface receives a combustion gas pressure generated in the combustion chamber, and the ruptured portion is bent and opened toward the diffuser portion,

after the part of the first closing member is ruptured along the fragile portion, the ruptured portion being bent from a non-ruptured portion and opened so that a gas discharge path from the combustion chamber to the diffuser portion is opened,

a control device restricting an angle between the second surface of the first closing member and the bent ruptured portion to be 5 degrees to 85 degrees,

the control device being,
a member which is adjusted to have such a distance that the ruptured portion of the first closing member is in contact therewith, or
a support portion which is formed to protrude from the second surface of the first closing member at a position such as to be in contact with the bent portion.

### BRIEF DESCRIPTION OF DRAWINGS

The present invention will become more fully understood from the detailed description given hereinbelow and the accompanying drawings which are given by way of illustration only, and thus are no limitative of the present invention and wherein:

FIG. 1 shows, in (a), a cross-sectional view in the axial direction of a gas generator according to the present invention. However, a control device is not shown. FIG. 1 shows, in (b), a plan view from the side of the second surface of the closing member used in (a) in FIG. 1;

FIG. 2 shows, in (a), a cross-sectional view illustrating a state after actuation of the gas generator shown in FIG. 1 and, in (b), a perspective view of (a) in FIG. 2;

FIG. 3 shows a cross-sectional view for explaining an operation of the closing member used in (a) in FIG. 1;

FIG. 4 shows, in (a), a cross-sectional view illustrating a control device in the gas generator shown in FIG. 1 and, in (b), a perspective view of (a) in FIG. 4;

FIG. 5 shows, in (a), a cross-sectional view illustrating a control device of another embodiment in the gas generator shown in FIG. 1 and, in (b), a cross-sectional view illustrating a state after actuation of (a) in FIG. 5;

FIG. 6 shows a cross-sectional view in the axial direction of a gas generator of another embodiment;

FIG. 7 shows, in (a), a plan view of the closing member taken from the side of the diffuser portion. A gas discharge port is shown by a broken line to clarify the positional relationship with the gas discharge port. FIG. 7 shows, in (b), a partial cross-sectional view in the axial direction of the gas generator including the closing member shown in (a) in FIG. 7;

FIG. 8 shows, in (a), a plan view of a closing member and, in (b) a plan view of a closing member of another embodiment which differs from that shown in (a) in FIG. 8. In (a) and (b) in FIG. 8, gas discharge ports are shown by broken lines to clarify the positional relationship with the gas discharge ports. FIG. 8 shows, in (c), a partial cross-sectional view in the axial direction of the gas generator including the closing member shown in (a) or (b) in FIG. 8;

FIG. 9 shows, in (a) , a plan view of a closing member and, in (b), a plan view of a closing member of an embodiment which differs from that shown in (a) in FIG. 9. In (a) and (b) in FIG. 9, gas discharge ports are shown by broken lines to clarify the positional relationship with the gas discharge ports. FIG. 9 shows, in (c), a partial cross-sectional view in the axial direction of the gas generator including the closing member shown in (a) or (b) in FIG. 9;

FIG. 10 shows, in (a), a plan view of a closing member. A gas discharge port is shown by a broken line to clarify the positional relationship with the gas discharge port. FIG. 10 shows, in (b), a partial cross-sectional view in the axial direction of the gas generator including the closing member shown in (a) in FIG. 10;

FIG. 11 shows a cross-sectional view in the axial direction of a gas generator of yet another embodiment;

FIG. 12 shows a cross-sectional view in the axial direction of a gas generator of yet another embodiment;

FIG. 13 shows a cross-sectional view in the axial direction illustrating a preferred embodiment of the gas generator shown in FIG. 12;

FIG. 14 shows a partially enlarged view (before actuation) of FIG. 13;

FIG. 15 shows a partially enlarged view (during actuation) of FIG. 13; and

FIG. 16 shows a partially enlarged view (after completion of actuation) of FIG. 13.

### DETAILED DESCRIPTION OF INVENTION

The present invention is to provide a gas generator capable of reducing a discharge amount of mist, which is generated during combustion, from the gas discharge port.

In the gas generator according to the first aspect, the second end surface of the cylindrical housing is closed by a closing member, and a fragile portion in a desired shape is formed in the closing member.

When a gas pressure is received on the first surface of the closing member at the time of actuation of the gas generator, the closing member is ruptured along the fragile portion, and then the ruptured portion is bent from a surface of a non-ruptured portion to the opposite side of the first surface.

A configuration of the fragile portion is not particularly limited, but the fragile portion is formed such that a non-ruptured portion remains even when the fragile portion is ruptured, and the ruptured portion does not fall off from the closing member and is bent from a surface of the non-ruptured portion.

For example, when the fragile portion formed in the closing member is composed of three sides of a quadrangle, the three sides are ruptured at the time of actuation, but the remaining one side of the quadrangle remains non-ruptured, and the ruptured portion formed of the three sides are bent from the non-ruptured side, thereby opening the closing member.

Here, to facilitate rupturing, the fragile portion may have a U-shape as a whole in which two corners formed by the three sides of a quadrangle are rounded.

The quadrangle may be a square, a rectangle, a trapezoid, an irregular shape, or the like.

For example, when the fragile portion formed in the closing member is composed of two sides of a triangle, two sides are ruptured at the time of actuation, but the remaining one side of the triangle remains non-ruptured, and the ruptured portion formed of the two sides are bent from the non-ruptured side, thereby opening the closing member.

Here, to facilitate rupturing, one corner between the two sides of the triangle may be rounded.

For example, when the fragile portion formed in the closing member is composed of a part of the circumference of a circle (for example, a length portion of 60% to 80% of the circumference), the length portion of 60% to 80% of the circumference is ruptured, but the length portion of 20% to 40% of the circumference remains non-ruptured, and the ruptured portion (the length portion of 60% to 80% of the circumference) is bent from a surface of the non-ruptured portion (the length portion of 20% to 40% of the circumference), thereby opening the closing member.

The circle may be an ellipse.

The gas generator of the first aspect has a control device for restricting an angle between the second surface of the closing member and the bent ruptured portion to be 5 degrees to 85 degrees when the ruptured portion of the closing member is bent and opened from the surface of the non-ruptured portion as described above.

Thus, when the ruptured portion is bent and opened from the surface of the non-ruptured portion, the ruptured portion is bent in a state of being inclined with respect to the second surface of the closing member (a state of being inclined at the abovementioned 5 degrees to 85 degrees). As a result, the combustion gas discharged from the opening collides with and bypasses the ruptured portion in the inclined state before being discharged, so that mist is easily captured thereby.

The control device is:
(I) a member which is adjusted to have such a distance that a part of the bent ruptured portion of the closing member is in contact therewith; or
(II) a support portion which is formed on the second surface of the closing member at a position such as to be in contact with a part of the bent ruptured portion.

The member of the control device (I) can be a plate-like member fixed at a position such as to cover the fragile portion to be ruptured at a distance therefrom on the side of the second end surface of the cylindrical housing.

The distance is set such that the angle of 5 degrees to 85 degrees between the ruptured portion and the second surface of the closing member is obtained when a part of the ruptured portion bent from the surface of the non-ruptured portion of the fragile portion comes into contact with the plate-like member and the bending stops.

The support portion serving as the control device (II) is a convex portion formed so as to protrude from the second surface of the closing member. A formation position and a shape of the convex portion and a height thereof from the second surface are set to have the angle of 5 degrees to 85 degrees between the ruptured portion and the second surface of the closing member when bending of the ruptured portion of the fragile portion bent from the surface of the non-ruptured portion stops.

In the second aspect, a cylindrical housing has therein a gas generation chamber accommodating a gas generating agent as a gas generating source, and a diffuser portion provided with a gas discharge port.

A gas generating agent is loaded in the gas generation chamber as a gas generating source, but both a gas generating agent and a pressurized gas may be loaded as a gas generating source.

A closing member closes between the gas generation chamber and the diffuser portion. A fragile portion in a desired shape is formed in the closing member.

When a gas pressure is received on a first surface of the closing member at the time of actuation of the gas generator, the closing member is ruptured along the fragile portion and then the ruptured portion is bent from a surface of the non-ruptured portion to the opposite side of the first surface.

A configuration of the fragile portion is not particularly limited, but the fragile portion is formed such that a non-ruptured portion remains even when the fragile portion is ruptured, and the ruptured portion does not fall off from the closing member and is bent from a surface of the non-ruptured portion.

For example, when the fragile portion formed in the closing member is composed of three sides of a quadrangle, the three sides are ruptured at the time of actuation, but the remaining one side of the quadrangle remains non-ruptured, and the ruptured portion formed of the three sides are bent from the non-ruptured side, thereby opening the closing member.

Here, to facilitate rupturing, the fragile portion may have a U-shape as a whole in which two corners formed by the three sides of a quadrangle are rounded.

The quadrangle may be a square, a rectangle, a trapezoid, an irregular shape, or the like.

For example, when the fragile portion formed in the closing member is composed of two sides of a triangle, two sides are ruptured at the time of actuation, but the remaining one side of the triangle remains non-ruptured, and the ruptured portion formed of the two sides are bent from the non-ruptured side, thereby opening the closing member.

Here, to facilitate rupturing, one corner between the two sides of the triangle may be rounded.

For example, when the fragile portion formed in the closing member is composed of a part of the circumference of a circle (for example, a length portion of 60% to 80% of the circumference), the length portion of 60% to 80% of the circumference is ruptured, but the length portion of 20% to 40% of the circumference remains non-ruptured, and the ruptured portion (the length portion of 60% to 80% of the circumference) is bent from a surface of the non-ruptured portion (the length portion of 20% to 40% of the circumference), thereby opening the closing member.

The circle may be an ellipse.

The gas generator of the second aspect has a control device for restricting an angle between the second surface of the closing member and the bent ruptured portion to be 5 degrees to 85 degrees when the ruptured portion of the closing member is bent and opened from the surface of the non-ruptured portion as described above.

Thus, when the ruptured portion is bent and opened from the surface of the non-ruptured portion, the ruptured portion is bent in a state of being inclined with respect to the second surface of the closing member (a state of being inclined at the abovementioned 5 degrees to 85 degrees). As a result, the combustion gas discharged from the opening collides with and then bypasses the ruptured portion in the inclined state before being discharged, so that mist is easily captured thereby.

The control device is:
(I) a diffuser portion which is adjusted to have such a distance that a part of the bent ruptured portion of the closing member is in contact therewith; or
(II) a support portion which is formed on the second surface of the closing member at a position such as to be in contact with a part of the bent ruptured portion.

The control device (I) is a wall surface of the diffuser portion, or can be a convex portion integrally formed with this wall surface.

The distance is such that the angle of 5 degrees to 85 degrees between the ruptured portion and the second surface of the closing member is obtained when a part of the ruptured portion bent from the surface of the non-ruptured portion of the fragile portion comes into contact with the above member and the bending stops.

The support portion serving as the control device (II) is a convex portion formed so as to protrude from the second surface of the closing member. A formation position and a shape of the convex portion and a height thereof from the second surface are set to have the angle of 5 degrees to 85 degrees between the ruptured portion and the second surface of the closing member when bending of the ruptured portion of the fragile portion bent from the surface of the non-ruptured portion stops.

A different (other) aspect of the second aspect of the present invention (hereinafter referred to as “the second—(1) aspect”) can provide a gas generator including a gas generation chamber which is a combustion chamber accommodating a gas generating agent and an ignition device,

a closing member closing between the combustion chamber and a diffuser portion,

the closing member having a first surface on the side of the combustion chamber and a second surface on the back side of the first surface,

the closing member having a fragile portion formed such that a part thereof is ruptured when the first surface receives a pressure of gas including a combustion gas generated in the combustion chamber, and the ruptured portion is bent and opened toward the diffuser portion,

after the part of the closing member is ruptured along the fragile portion, the ruptured portion being bent from a non-ruptured surface and opened so that a combustion gas discharge path leading to a gas discharge port is opened,

a control device restricting an angle between the second surface of the closing member and the bent ruptured portion to be 5 degrees to 85 degrees,

the control device being a wall surface of the diffuser portion which is adjusted to have such a distance that the bent ruptured portion of the closing member is in contact therewith, or a support portion which is formed to protrude from the second surface of the closing member at a position such as to be in contact with the bent ruptured portion.

In other words, it is possible in the gas generator according to the second—(1) aspect that the gas generation chamber is a combustion chamber accommodating the gas generating agent and the ignition device,

the part of a closing member is ruptured and opened when the first surface receives a gas pressure of a combustion gas generated in the combustion chamber, so that a combustion gas discharge path leading to the gas discharge port is opened.

In the second—(1) aspect, the gas generation chamber according to the second aspect includes the combustion chamber accommodating the gas generating agent and the ignition device, and the closing member closes between the combustion chamber and the diffuser portion.

The fragile portion is formed in the closing member, and further the control device is provided.

At the time of actuation, the closing member is opened in the same manner as in the second aspect.

A yet different (other) aspect of the second aspect of the present invention can provide a gas generator including a gas generation chamber which is a combination of a combustion chamber accommodating a gas generating agent and an ignition device, and a pressurized gas chamber filled with a gas,

the combustion chamber being arranged on the side of a first end surface of a cylindrical housing, a diffuser portion which is provided with a gas discharge port being arranged on the side of a second end surface which is axially opposite to the first end surface of the cylindrical housing, and the pressurized gas chamber being arranged between the combustion chamber and the diffuser portion,

a first closing member closing between the combustion chamber and the pressurized gas chamber, and a second closing member closing between the pressurized gas chamber and the diffuser portion,

the first closing member having a first surface on the side of the combustion chamber and a second surface on the back side of the first surface, which is on the side of the pressurized gas chamber,

the second closing member having a first surface on the side of the pressurized gas chamber and a second surface on the back side of the first surface, which is on the side of the diffuser portion,

the first closing member having a fragile portion formed such that a part thereof is ruptured when the first surface receives a combustion gas pressure generated in the combustion chamber, and the ruptured portion is bent and opened toward the pressurized gas chamber,

after the part of the first closing member is ruptured along the fragile portion, the ruptured portion being bent from a non-ruptured portion and opened so that a gas discharge path from the combustion chamber to the pressurized gas chamber is opened,

a control device restricting an angle between the second surface of the first closing member and the bent ruptured portion to be 5 degrees to 85 degrees,

the control device being a support portion which is formed to protrude from the second surface of the first closing member at a position such as to be in contact with the bent ruptured portion,

the second closing member having a fragile portion formed such that a part thereof is ruptured when the first surface receives a gas pressure of a combustion gas generated in the combustion chamber and a pressurized gas, and the ruptured portion is bent and opened toward the diffuser portion,

after the part of the second closing member is ruptured along the fragile portion, the ruptured portion being bent from a non-ruptured portion and opened so that a gas discharge path from the pressurized gas chamber to the diffuser portion is opened,

a control device restricting an angle between the second surface of the second closing member and the bent ruptured portion to be 5 degrees to 85 degrees,

the control device being a wall surface of the diffuser portion which is adjusted to have such a distance that the bent ruptured portion of the second closing member is in contact therewith, or a support portion which is formed to protrude from the second surface of the second closing member at a position such as to be in contact with the bent ruptured portion.

In the third aspect, the gas generation chamber is a combination of the combustion chamber accommodating the gas generating agent and the ignition device, and the pressurized gas chamber filled with a gas.

The combustion chamber and the pressurized gas chamber are arranged such that the combustion chamber is arranged on the side of the first end surface of the cylindrical housing, the diffuser portion provided with the gas discharge port is arranged on the side of the second end surface which is axially opposite to the first end surface of the cylindrical housing, and the pressurized gas chamber is arranged between the combustion chamber and the diffuser portion.

The first closing member closes between the combustion chamber and the pressurized gas chamber, and the second closing member closes between the pressurized gas chamber and the diffuser portion.

At the time of actuation of the gas generator, the first closing member opens upon receipt of a combustion gas pressure generated in the combustion chamber, and the combustion gas flows into the pressurized gas chamber.

A pressure in the pressurized gas chamber rises due to the combustion gas flowing into the pressurized gas chamber, the second closing member opens upon receipt of the gas pressure, and then the combustion gas and the pressurized gas flow into the diffuser portion and are finally discharged from the gas discharge port.

The same fragile portion as that in the second aspect is formed in the first closing member.

The control device for the bent ruptured portion when the first closing member is ruptured at the fragile portion is a support portion (a convex portion) which is formed to protrude from the second surface of the first closing member at a position such as to be in contact with the bent ruptured portion.

The support portion (the convex portion) can be the same as the control device (II) in the second aspect.

The same fragile portion as that in the second aspect is formed in the second closing member.

The control device for the bent ruptured portion when the second closing member is ruptured at the fragile portion is a wall surface of the diffuser portion adjusted to have a distance such as to be in contact with the bent ruptured portion of the second closing member, or a support portion which is formed to protrude from the second surface of the second closing member at a position such as to be in contact with the bent ruptured portion.

The control device of the second closing member can be the same as the control device (I) or (II) in the second aspect.

At the time of actuation, the first closing member and the second closing member are opened in the same manner as in the second aspect.

A yet different (other) aspect of the second aspect of the present invention can be a gas generator including a gas generation chamber being a combination of a combustion chamber accommodating a gas generating agent and an ignition device, and a pressurized gas chamber filled with a gas,

the combustion chamber being arranged on the side of a first end surface of a cylindrical housing, the pressurized gas chamber being arranged on the side of a second end surface which is axially opposite to the first end surface of the cylindrical housing, and a diffuser portion being arranged between the combustion chamber and the pressurized gas chamber,

a first closing member closing between the combustion chamber and the diffuser portion, and a second closing member closing between the diffuser portion and the pressurized gas chamber,

the first closing member having a first surface on the side of the combustion chamber and a second surface on the back side of the first surface, which is on the side of the diffuser portion,

the first closing member having a fragile portion formed such that a part thereof is ruptured when the first surface receives a combustion gas pressure generated in the combustion chamber, and the ruptured portion is bent and opened toward the diffuser portion,

after the part of the first closing member is ruptured along the fragile portion, the ruptured portion being bent from a non-ruptured portion and opened so that a gas discharge path from the combustion chamber to the diffuser portion is opened,

a control device restricting an angle between the second surface of the first closing member and the bent ruptured portion to be 5 degrees to 85 degrees,

the control device being a member which is adjusted to have such a distance that the bent ruptured portion of the first closing member is in contact therewith, or a support portion which is formed to protrude from the second surface of the first closing member at a position such as to be in contact with the bent ruptured portion.

In the fourth aspect, the gas generation chamber is a combination of the combustion chamber accommodating the gas generating agent and the ignition device, and the pressurized gas chamber filled with a gas.

The combustion chamber and the pressurized gas chamber are arranged such that the combustion chamber is arranged on the side of the first end surface of the cylindrical housing, the pressurized gas chamber is arranged on the side of the second end surface which is axially opposite to the first end surface of the cylindrical housing, and the diffuser portion is arranged between the combustion chamber and the pressurized gas chamber.

At the time of actuation of the gas generator, the first closing member is opened upon receipt of a combustion gas pressure generated in the combustion chamber, and the combustion gas flows into the diffuser portion and is finally discharged from the gas discharge port.

Further, a pressure in the diffuser portion rises due to the combustion gas flowing into the diffuser portion. As a result, the second closing member is opened by utilizing the pressure rise, and after the pressurized gas flows into the diffuser portion, the gas is discharged from the gas discharge port.

A means for opening the second closing member can be directly using the gas pressure, a breaking device using the gas pressure, or the like.

The same fragile portion as that in the second aspect is formed in the first closing member.

The control device for the bent ruptured portion when the first closing member is ruptured at the fragile portion is a support portion which is formed to protrude from the second surface of the first closing member at a position such as to be in contact with the bent ruptured portion.

The support portion can be the same as the control device (II) in the second aspect.

Alternatively, the control device for the bent ruptured portion when the first closing member is ruptured at the fragile portion can be the same as the control device (I) in the first aspect.

At the time of actuation, the first closing member is opened in the same manner as in the second aspect.

The second closing member may have a fragile portion or may not have a fragile portion.

When the second closing member has a fragile portion, the fragile portion may be the same as or different from that in the second aspect. The different fragile portion can be, for example, a fragile portion formed radially.

In the gas generator of the present invention, a part (a tab) of the closing member is ruptured in a state in which a pressure in the combustion chamber having a gas generating agent is sufficiently increased, and the tab is bent and opened. Since a combustion gas flowing out from the combustion chamber through the opening collides with and then bypasses the tab before being discharged, mist is easily captured on the tab surface.

The gas generator of the present invention is usable for an airbag apparatus mounted on a vehicle.

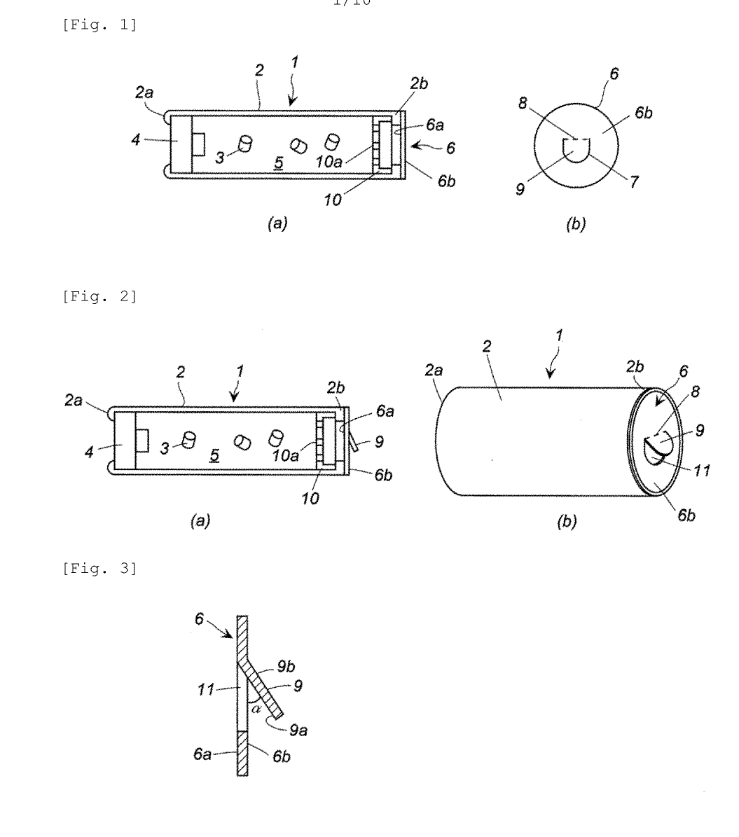

### Embodiments of Invention <Gas Generator in FIGS. 1 and 2>

A gas generator 1 shown in (a) in FIG. 1 has a cylindrical housing 2 and therein a gas generation chamber 5 accommodating gas generating agents 3 as a gas generating source and an igniter 4.

The igniter 4 is fixed to a first end surface 2a of the cylindrical housing 2, and a second end surface 2b of the cylindrical housing 2 on the side axially opposite to the first end surface 2a is closed by a closing member 6.

A periphery of the closing member 6 is welded and fixed to an annular portion protruding inward from an inner circumferential wall surface of the cylindrical housing 2 at the second end surface 2b.

A retainer 10 having a plurality of through holes 10a is disposed in the gas generation chamber 5. The retainer 10 minimizes gaps between gas generating agents 3 charged therein and prevents contact between the gas generating agents 3 and the closing member 6.

The closing member 6 shown in (a) and (b) in FIG. 1 has a first surface 6a on the side of the gas generation chamber 5 and a second surface 6b on the back side of the first surface 6a.

The closing member 6 has a U-shaped fragile portion 7 in the second surface 6b, but may have the fragile portion 7 in the first surface 6a.

The fragile portion 7 can be any portion which has lower strength than other portions and can be, for example, a groove having a V-shaped cross section or the like.

When the first surface 6a receives a pressure of gas including a combustion gas, the first surface 6a is ruptured along the U-shaped fragile portion 7 and a portion (a tab) 9 ruptured along the U-shaped fragile portion 7 is bent from a surface of a non-ruptured portion 8 and opens to be a gas discharge port 11 ((a) and (b) in FIG. 2).

In (b) in FIG. 1, the fragile portion 7 is formed in one location, but the fragile portion can be formed in a plurality of locations so that a plurality of the tabs 9 are bent to open a plurality of the gas discharge ports 11.

The gas generator 1 shown in FIG. 1 has a control device, so that an angle (α) between the second surface 6b of the closing member 6 and the bent ruptured portion (the tab) 9 is restricted to be 5 degrees to 85 degrees.

As shown in FIG. 3, the angle (α) is an angle between the second surface 6b of the closing member 6 and an inner side surface (a surface closer to the second surface 6b of the closing member 6) 9a of the ruptured portion (the tab) 9.

The angle (α) can be selected from the above range according to components of the gas generating agent, a performance of the gas generator, and the like.

For example, in order to increase a gas outflow rate, the angle is increased within the range of 5 degrees to 85 degrees (preferably 60 degrees to 85 degrees).

For example, in order to enhance an effect of capturing mist in the gas, the angle can be reduced within the range of 5 degrees to 85 degrees (preferably 5 degrees to 40 degrees).

For example, in order to obtain satisfactory balance of the gas outflow rate and the mist capturing effect, the angle can be approximately an intermediate angle between the above ranges within the range of 5 degrees to 85 degrees (preferably 40 degrees to 60 degrees).

A control device shown in FIG. 4 or FIG. 5 can be used as the control device.

A control device 15 shown in FIG. 4 has a rectangular main body 16, and a first leg portion 17a and a second leg portion 17b extending in the same direction from the short sides on both ends of the rectangular main body 16.

Inner side surfaces of the first leg portion 17a and the second leg portion 17b are welded and fixed to an outer circumferential surface of the cylindrical housing 2.

A predetermined distance is obtained between the main body 16 and the closing member 6 (the second surface 6b) by adjusting the fixing positions of the first leg portion 17a and the second leg portion 17b.

The predetermined distance is a distance to set the angle (α) shown in FIG. 3 to be 5 degrees to 85 degrees when the ruptured tab 9 is bent at the time of actuation, a distal end portion of the tab 9 abuts against the main body 16, and the bending is stopped.

A control device shown in FIG. 5 is a convex portion (a support portion) 20 formed on the second surface 6b of the closing member 6.

The convex portion 20 is a member separate from the closing member 6 and fixed to protrude from the second surface 6b.

A shape of the convex portion 20 is not particularly limited, and the convex portion 20 can have a trapezoid cross-sectional shape such as shown in FIG. 5, or a triangle, square, rectangular, or irregular cross-sectional shape.

The convex portion 20 shown in FIG. 5 has an inclined surface 21 facing the second surface 6b.

An angle between the inclined surface 21 of the convex portion 20 and the second surface 6b is set such that the angle (α) shown in FIG. 3 becomes 5 degrees to 85 degrees when the ruptured tab 9 is bent at the time of actuation, the outer side surface 9b of the tab 9 abuts against the inclined surface 21, and the bending is stopped.

An operation of the gas generator 1 shown in (a) in FIG. 1 will be described hereinbelow.

When the igniter 4 is actuated, the gas generating agents 3 in the gas generation chamber 5 are ignited and burnt to generate a combustion gas.

When the combustion gas applies pressure to the closing member 6 after passing through the through holes 10a of the retainer 10, the U-shaped fragile portion 7 shown in (b) in FIG. 1 is ruptured, and the tab 9 is bent from a surface of the non-ruptured portion 8 as shown in FIG. 2.

At this time, as the bending of the tab 9 is stopped by the control device 15 shown in FIG. 4 or the control device (the convex portion 20) shown in FIG. 5, the gas discharge port 11 is opened in a state in which the angle (α) between the inner side surface 9a of the tab 9 and the second surface 6b of the closing member (FIG. 3) is restricted within the range of 5 degrees to 85 degrees.

When the combustion gas in the gas generation chamber 5 is discharged from the gas discharge port 11, the gas necessarily collides with and then bypasses the inner side surface 9a of the tab 9. Therefore, mist adheres to the inner side surface 9a and is captured thereby.

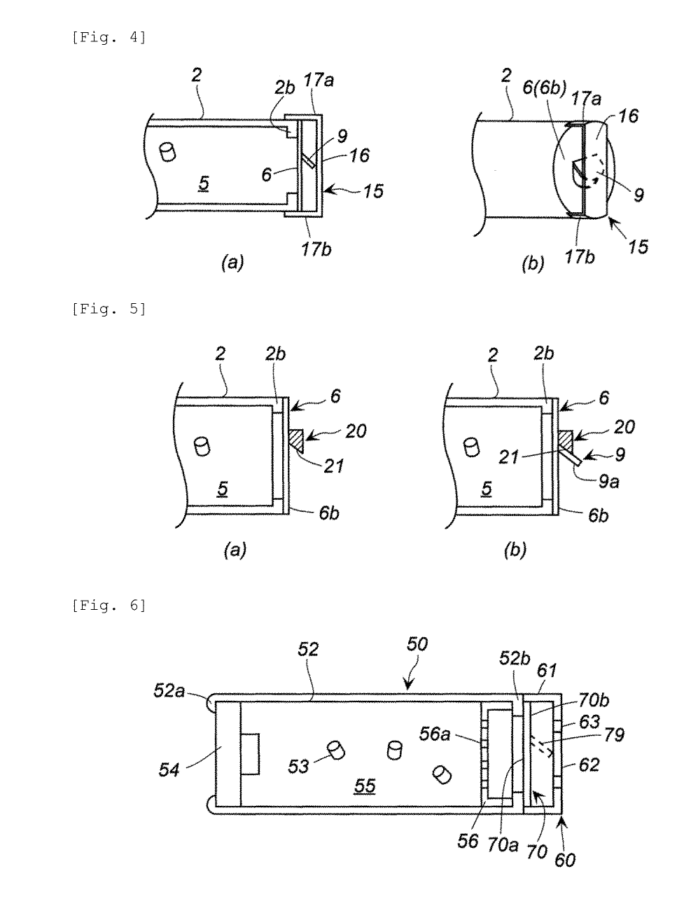

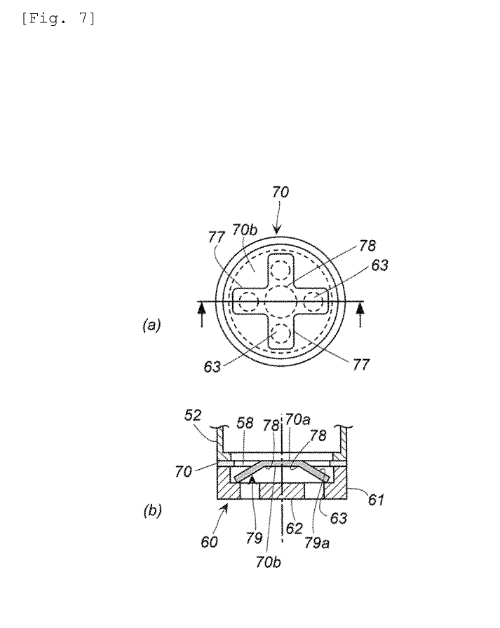

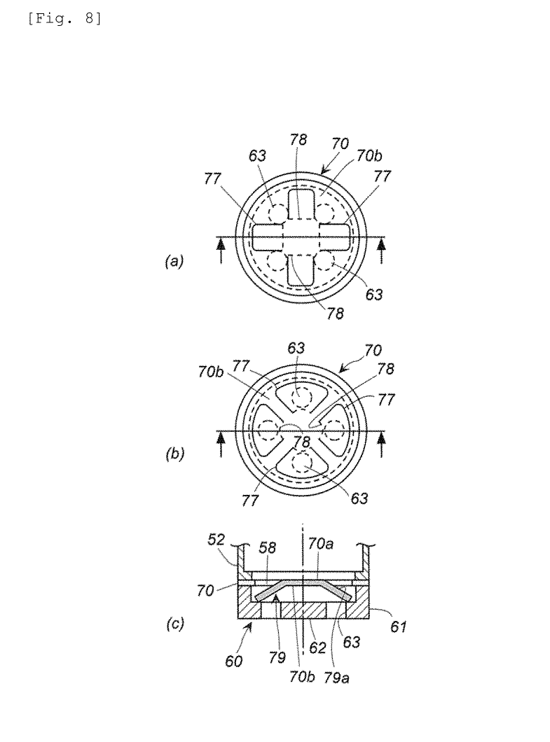

In the gas generator 1 shown in FIG. 1, the combustion gas in the gas generation chamber 5 is discharged directly from the gas discharge port 11. Therefore, the gas generator 1 is suitable in the case where a gas generating agent generating a small amount of mist is used as the gas generating agents 3.

<Gas Generator Shown in FIG. 6>

A gas generator 50 shown in FIG. 6 has a cylindrical housing 52, and therein a combustion chamber 55 accommodating gas generating agents 53 as a gas generating source, and a diffuser portion 60.

An igniter 54 is fixed to a first end surface 52a of the cylindrical housing 52, and the diffuser portion 60 is attached to a second end surface 52b of the cylindrical housing 52 which is axially opposite to the first end surface 52a.

A retainer 56 having a plurality of through holes 56a is disposed in the combustion chamber 55. The retainer 56 minimizes gaps between the gas generating agents 53 charged therein and prevents contact between the gas generating agents 53 and a closing member 70.

The diffuser portion 60 has the same shape and the same outer diameter of the radial cross section as the cylindrical housing 52 and has a circumferential surface 61 and a bottom surface 62.

A plurality of gas discharge ports 63 are formed in the bottom surface 62.

The closing member 70 closes between the combustion chamber 55 and the diffuser portion 60.

A periphery of the closing member 70 is welded and fixed to an annular portion protruding inward from the inner circumferential wall surface of the cylindrical housing 52 at the second end surface 52b.

The closing member 70 has a first surface 70a on the side of the combustion chamber 55 and a second surface 70b on the side of the diffuser portion 60.

The closing member 70 can be the same as the closing member 6 shown in (b) in FIG. 1. The closing member 70 has a fragile portion in the second surface 70b, but may have a fragile portion in the first surface 70a.

In FIG. 6, the reference numeral 79 denotes a portion (a tab) where the fragile portion of the closing member 70 is ruptured at the time of actuation.

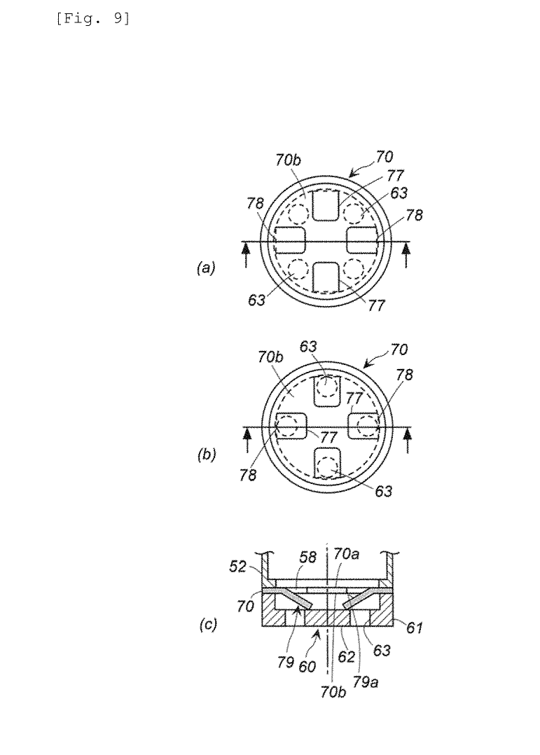

Preferred embodiments of the closing member 70 will be described with reference to FIGS. 7 to 10.

(FIG. 7)

In FIG. 7, (a) in FIG. 7 shows a plan view (before actuation) of the closing member as viewed from the side of the diffuser portion 60, and (b) in FIG. 7 is a radial sectional view (after actuation) including the second end surface 52b of the cylindrical housing 52 and the diffuser portion 60.

As shown in (a) in FIG. 7, a fragile portion 77 formed in a cross shape is provided in the second surface 70b of the closing member 70. The corners of the cross are rounded.

A circle indicated by a broken line in the central portion of the fragile portion 77 formed in a cross shape is the non-ruptured portion (a bending portion) 78 which is not ruptured.

In the state in (a) in FIG. 7, it is shown that the four gas discharge ports 63 of the diffuser portion are disposed at positions such as to axially face the fragile portion 77 formed in the cross shape.

As shown in (b) in FIG. 7, when a combustion gas pressure is received from the combustion chamber 55, the fragile portion 77 of the closing member 70 is ruptured in a cross shape and the four tabs 79 are bent from the surface of the non-ruptured circular portion (the bending portion) 78 toward the diffuser portion 60.

Thereafter, the distal end portions of the four tabs 79 abut against the bottom surface 62 of the diffuser portion 60, thereby stopping the bending.

At this time, an angle between each tab 79 and the second surface 70b is within the range of the angle (α) (5 degrees to 85 degrees) shown in FIG. 3, and a distance between the second surface 70b and the bottom surface 62 is adjusted such that the above angle (α) is obtained.

The bottom surface 62 is a flat surface, but a convex portion may be formed on the bottom surface 62 at a portion where the tab 79 abuts in order to adjust the distance (the angle (α)) between the bottom surface 62 and the second surface 70b.

In this way, the four tabs 79 are bent and opened (openings 58), and the combustion chamber 55 and the diffuser portion 60 are communicated with each other.

In FIG. 7, since the surface of the non-ruptured portion (the bending portion) 78 is located at the center portion of the closing member 70, bending and opening proceed from a portion close to an outer circumference of the closing member 70.

When the combustion gas in the combustion chamber 55 is discharged from the openings 58 into the diffuser portion 60, the gas necessarily collides with and then bypasses the inner side surfaces 79a of the tabs 79. Therefore, mist adheres to the inner side surfaces 79a and is easily captured thereby.

(FIG. 8)

In FIG. 8, (a) in FIG. 8 shows a plan view (before actuation) of the closing member as viewed from the side of the diffuser portion 60, (b) in FIG. 8 shows a plan view (before actuation) of the closing member of an embodiment other than that shown in (a) in FIG. 8, and (c) in FIG. 8 shows a radial sectional view (after actuation) including the second end surface 52b of the cylindrical housing 52 and the diffuser portion 60, this view being common to both (a) in and (b) in FIG. 8.

As shown in (a) in FIG. 8, the second surface 70b of the closing member 70 has fragile portions 77 arranged separately at four locations, each thereof being formed of three sides of a quadrangle. Corners of thereof are rounded.

The remaining side of the quadrangle at each fragile portion 77 formed of three sides and separately at four locations is a non-ruptured portion (a bending portion) 78. This portion is indicated by a broken line.

In the state in (a) in FIG. 8, it is shown that the four gas discharge ports 63 of the diffuser portion are arranged at positions such as not to axially face the fragile portions 77 each formed of three sides of a quadrangle.

As shown in (b) in FIG. 8, the second surface 70b of the closing member 70 has fragile portions 77 arranged separately at four locations, each thereof being formed in a substantially fan shape (a fan shape has two sides each corresponding to a radius and a long circular arc between the two sides, but the two sides do not intersect at the portion radially opposite to the long circular arc). Corners thereof are rounded.

A short circular arc opposite to the long circular arc in each substantially fan shape arranged at four locations is the non-ruptured portion (a bending portion) 78.

In the state in (b) in FIG. 8, it is shown that the four gas discharge ports 63 of the diffuser portion are arranged at positions such as to axially face the fragile portions 77 in a substantially fan shape.

As shown in (c) in FIG. 8, when a combustion gas pressure is received from the combustion chamber 55, the fragile portions 77 of the closing member 70 are ruptured at four locations and the four tabs 79 are bent from the surface of the non-ruptured portion (the bending portion) 78 toward the diffuser portion 60.

Thereafter, the distal end portions of the four tabs 79 abut against the bottom surface 62 of the diffuser portion 60, thereby stopping the bending.

At this time, an angle between each tab 79 and the second surface 70b is within the range of the angle (α) (5 degrees to 85 degrees) shown in FIG. 3, and a distance between the second surface 70b and the bottom surface 62 is adjusted such that the above angle (α) is obtained.

The bottom surface 62 is a flat surface, but a convex portion may be formed on the bottom surface 62 at a portion where the tab 79 abuts in order to adjust the distance (the angle (α)) between the bottom surface 62 and the second surface 70b.

In this way, the four tabs 79 are bent and opened (openings 58), and the combustion chamber 55 and the diffuser portion 60 are communicated with each other.

In FIG. 8, since the non-ruptured portion (the bending portion) 78 is located at the center portion of the closing member 70, bending and opening proceed from a portion close to the outer circumference of the closing member 70.

When the combustion gas in the combustion chamber 55 is discharged from the openings 58 into the diffuser portion 60, the gas necessarily collides with and then bypasses the inner side surfaces 79a of the tabs 79. Therefore, mist adheres to the inner side surfaces 79a and is easily captured thereby.

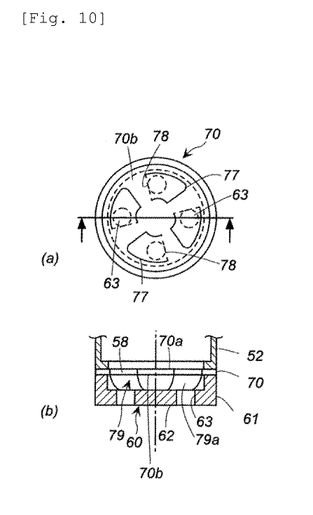

(FIG. 9)

In FIG. 9, (a) in FIG. 9 shows a plan view (before actuation) of the closing member as viewed from the side of the diffuser portion 60, (b) in FIG. 9 shows a plan view (before actuation) of the closing member of an embodiment other than that shown in (a) in FIG. 9, and (c) in FIG. 9 shows a radial sectional view (after actuation) including the second end surface 52b of the cylindrical housing 52 and the diffuser portion 60, this view being common to both (a) in and (b) in FIG. 9.

As shown in (a) in FIG. 9, the second surface 70b of the closing member 70 has fragile portions 77 arranged separately at four locations, each thereof being formed of three sides of a quadrangle. Corners of thereof are rounded.

The remaining side of the quadrangle at each fragile portion 77 formed of three sides and separately at four locations is the non-ruptured portion (a bending portion) 78. This portion is indicated by a broken line.

In the state in (a) in FIG. 9, it is shown that the four gas discharge ports 63 of the diffuser portion are arranged at positions such as not to axially face the fragile portions 77 each formed of three sides of a quadrangle.

As shown in (b) in FIG. 9, the second surface 70b of the closing member 70 has fragile portions 77 arranged separately at four locations, each thereof being formed of three sides of a quadrangle. Corners thereof are rounded.

The remaining side of the quadrangle at each fragile portion 77 formed of three sides and separately at four locations is the non-ruptured portion (a bending portion) 78. This portion is indicated by a broken line.

In the state in (b) in FIG. 9, it is shown that the four gas discharge ports 63 of the diffuser portion are arranged at positions such as to axially face the fragile portions 77 each formed of three sides of a quadrangle.

As shown in (c) in FIG. 9, when a combustion gas pressure is received from the combustion chamber 55, the fragile portions 77 of the closing member 70 are ruptured at four locations and the four tabs 79 are bent from the surface of the non-ruptured portion (the bending portion) 78 toward the diffuser portion 60.

Thereafter, the distal end portions of the four tabs 79 abut against the bottom surface 62 of the diffuser portion 60, thereby stopping the bending.

At this time, an angle between each tab 79 and the second surface 70b is within the range of the angle (α) (5 degrees to 85 degrees) shown in FIG. 3, and a distance between the second surface 70b and the bottom surface 62 is adjusted such that the above angle (α) is obtained.

The bottom surface 62 is a flat surface, but a convex portion may be formed on the bottom surface 62 at a portion where the tab 79 abuts in order to adjust the distance (the angle (α)) between the bottom surface 62 and the second surface 70b.

In this way, the four tabs 79 are bent and opened (openings 58), and the combustion chamber 55 and the diffuser portion 60 are communicated with each other.

In FIG. 9, since the non-ruptured portion (the bending portion) 78 is located close to an outer circumference of the closing member 70, bending and opening proceed from a portion close to the center portion of the closing member 70.

When the combustion gas in the combustion chamber 55 is discharged from the openings 58 into the diffuser portion 60, the gas necessarily collides with and then bypasses the inner side surfaces 79a of the tabs 79. Therefore, mist adheres to the inner side surfaces 79a and is easily captured thereby.

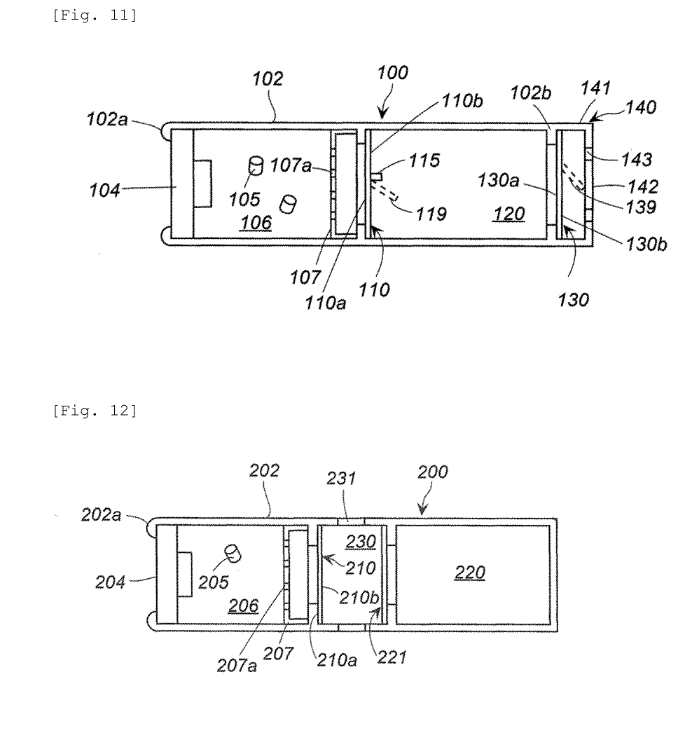

(FIG. 10)

In FIG. 10, (a) in FIG. 10 shows a plan view (before actuation) of the closing member as viewed from the side of the diffuser portion 60, (b) in FIG. 10 shows a radial sectional view (after actuation) including the second end surface 52b of the cylindrical housing 52 and the diffuser portion 60.

As shown in (a) in FIG. 10, the second surface 70b of the closing member 70 has fragile portions 77 arranged separately at four locations, each thereof being formed of an irregular shape surrounded by three sides. Corners thereof are rounded.

Each irregular shape surrounded by three sides and formed at four locations is in a shape surrounded by a long side along the circumference of the closing member 70, a short side along the circumference radially spaced from the long side and a connecting side radially connecting a first end of the long side and a first end of the short side.

A side circumferentially opposite to the connecting side of each of the irregular shapes surrounded by three sides (a side connecting a second end of the long side and a second end of the short side) is the non-ruptured portion (a bending portion) 78.

In the state in (a) in FIG. 10, it is shown that the four gas discharge ports 63 of the diffuser portion are arranged at positions such as to axially face the fragile portions 77 of the irregular shape.

As shown in (b) in FIG. 10, when a combustion gas pressure is received from the combustion chamber 55, the fragile portions 77 of the closing member 70 are ruptured at four locations and the four tabs 79 are bent from the surfaces of the non-ruptured portions (the bending portion) 78 toward the diffuser portion 60.

Thereafter, the distal end portions of the four tabs 79 abut against the bottom surface 62 of the diffuser portion 60, thereby stopping the bending.

At this time, an angle between each tab 79 and the second surface 70b is within the range of the angle (α) (5 degrees to 85 degrees) shown in FIG. 3, and a distance between the second surface 70b and the bottom surface 62 is adjusted such that the above angle (α) is obtained.

The bottom surface 62 is a flat surface, but a convex portion may be formed on the bottom surface 62 at a portion where the tab 79 abuts in order to adjust the distance (the angle (α)) between the bottom surface 62 and the second surface 70b.

In this way, the four tabs 79 are bent and opened (openings 58), and the combustion chamber 55 and the diffuser portion 60 are communicated with each other.

In FIG. 10, since the non-ruptured portions (the bending portions) 78 are formed at intervals in the circumferential direction of the closing member 70, the surface of each non-ruptured portion 78 is bent and opened in the circumferential direction of the closing member 70.

When the combustion gas in the combustion chamber 55 is discharged from the openings 58 into the diffuser portion 60, the gas necessarily collides with and then bypasses the inner side surfaces 79a of the tabs 79. Therefore, mist adheres to the inner side surfaces 79a and is easily captured thereby.

In FIGS. 7 to 10, the bottom surface 62 of the diffuser portion 60 is used as the control device for the bending angle (α) of the tab 79. However, the convex portion 20 such as shown in FIG. 5 can be formed on the second surface 70b of the closing member 70 and used as the control device.

When the convex portion 20 such as shown in FIG. 5 is used as the control device, the distance between the second surface 70b and the bottom surface 62 can be made larger than the distance shown in FIGS. 7 to 10. Therefore, the gas discharge port 63 can also be formed, if required, on a circumferential surface 61 of the diffuser portion 60.

(3) Gas Generator Shown in FIG. 11

A gas generator 100 shown in FIG. 11 has a cylindrical housing 102, and therein a combustion chamber 106 accommodating gas generating agents 105 as a gas generating source, a pressurized gas chamber 120 filled with a gas (argon, helium, or the like) and a diffuser portion 140 formed with a discharge port 143.

A first closing member 110 closes between the combustion chamber 106 and the pressurized gas chamber 120.

A periphery of the first closing member 110 is welded and fixed to an annular portion protruding inward from the inner circumferential wall surface of the cylindrical housing 102.

The first closing member 110 has a first surface 110a on the side of the combustion chamber 106 and a second surface 110b on the side of the pressurized gas chamber 120.

The first closing member 110 can be the same as the closing member 6 shown in (b) in FIG. 1 or the closing member 70 shown in the plan views of FIGS. 7 to 10, but in this configuration, a convex portion 115 which serves as a control device and functions in the same manner as the convex portion 20 shown in FIG. 5 is formed on the second surface 110b of the first closing member 110.

The first closing member 110 has a fragile portion in the second surface 110b, but a fragile portion may be formed in the first surface 110a.

A second closing member 130 closes between the pressurized gas chamber 120 and the diffuser portion 140.

A periphery of the second closing member 130 is welded and fixed to an annular portion protruding inward from an inner circumferential wall surface at an second end 102b of the cylindrical housing 102.

The second closing member 130 has a first surface 130a on the side of the pressurized gas chamber 120 and a second surface 130b on the side of the diffuser portion.

The second closing member 130 can be the same as the closing member 6 shown in (b) in FIG. 1, or the closing member 70 shown in the plan views of FIGS. 7 to 10.

The second closing member 130 has a fragile portion in the second surface 130b, but may have a fragile portion in the first surface 130a.

An igniter 104 is fixed to the first end surface 102a of the cylindrical housing 102.

A retainer 107 having a plurality of through holes 107a is disposed in the combustion chamber 106 so as to minimize gaps between the filled gas generating agents 105 and to prevent contact between the gas generating agents 105 and the first closing member 110.

The diffuser portion 140 has the same shape and the same outer diameter of the cross section in the radial direction as the cylindrical housing 102, and has a peripheral surface 141 and a bottom surface 142.

A plurality of gas discharge ports 143 are formed in the bottom surface 142.

An operation of the gas generator 100 shown in FIG. 11 will be described hereinbelow.

When the igniter 104 is actuated, the gas generating agents 105 in the combustion chamber 106 are ignited and burnt to generate combustion gas.

When the combustion gas applies pressure to the first closing member 110 through the through holes 107a of the retainer 107, the fragile portion is ruptured as shown in the cross-sectional views of FIGS. 7 to 10, and a tab 119 is bent from the surface of the non-ruptured portion.

At this time, as shown in FIG. 5, the bending of the tab 119 is stopped by the convex portion 115, whereby the opening is restricted to be within the range of the angle (α) of 5 degrees to 85 degrees.

When the combustion gas in the combustion chamber 106 is discharged from the opening formed in the first closing member 110 into the pressurized gas chamber 120, the combustion gas necessarily collies with and then bypasses the tab 119 before being discharged. Therefore, mist adheres to the tab 119 and is easily captured thereby.

As a pressure in the pressurized gas chamber 120 rises due to the combustion gas flowing thereinto, the pressure is applied to the second closing member 130, the fragile portion is ruptured as shown in the cross-sectional views of FIGS. 7 to 10, and a tab 139 is bent from the surface of the non-ruptured portion.

At this time, as shown in the cross-sectional views of FIGS. 7 to 10, the bending of the tab 139 is stopped, whereby the opening is restricted to be within the range of the angle (α) of 5 degrees to 85 degrees.

When a mixed gas of the combustion gas and the pressurized gas in the pressurized gas chamber 120 is discharged from the opening formed in the second closing member 130 into the diffuser portion 140, the mixed gas necessarily collides with and then bypasses the tab 139 before being discharged. Therefore, mist adheres to the tab 139 and is easily captured thereby.

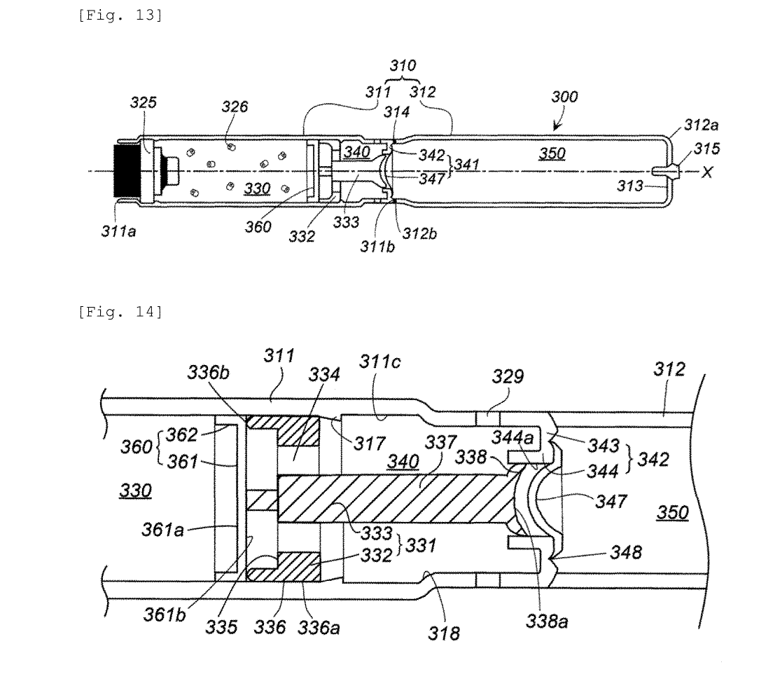

The mixed gas discharged into the diffuser portion 140 is discharged from the gas discharge port 143.

<Gas Generator Shown in FIG. 12>

A gas generator 200 shown in FIG. 12 has a cylindrical housing 202 and therein a combustion chamber 206 accommodating gas generating agents 205 as a gas generating source, a pressurized gas chamber 220 charged with a gas (argon, helium, or the like) and a diffuser portion 230 formed with a discharge port 231.

A first closing member 210 closes between the combustion chamber 206 and the diffuser portion 230.

A periphery of the first closing member 210 is welded and fixed to an annular portion protruding inward from the cylindrical housing 202.

The first closing member 210 has a first surface 210a on the side of the combustion chamber 206 and a second surface 210b on the side of the diffuser portion 230.

The first closing member 210 can be the same as the closing member 6 shown in (b) in FIG. 1 or the closing member 70 shown in the plan views of FIGS. 7 to 10, but in this configuration, a convex portion (not shown) which serves as a control device and functions in the same manner as the convex portion 20 shown in FIG. 5 is formed on the second surface 210b.

The first closing member 210 has a fragile portion in the second surface 210b, but a fragile portion may be formed in the first surface 210a.

A second closing member 221 closes between the pressurized gas chamber 220 and the diffuser portion 230.

A periphery of the second closing member 221 is welded and fixed to an annular portion protruding inward from an inner circumferential wall surface of the cylindrical housing 202.

Since the second closing member 221 is not required to capture mist, the second closing member does not have a fragile portion such as that in the first closing member 210, but the second closing member may have a fragile portion (for example, a fragile portion formed radially) to facilitate rupturing.

An igniter 204 is fixed to the first end surface 202a of the cylindrical housing 202.

A retainer 207 having a plurality of through holes 207a is disposed in the combustion chamber 206 so as to minimize gaps between the filled gas generating agents 205 and to prevent contact between the gas generating agents 205 and the first closing member 210.

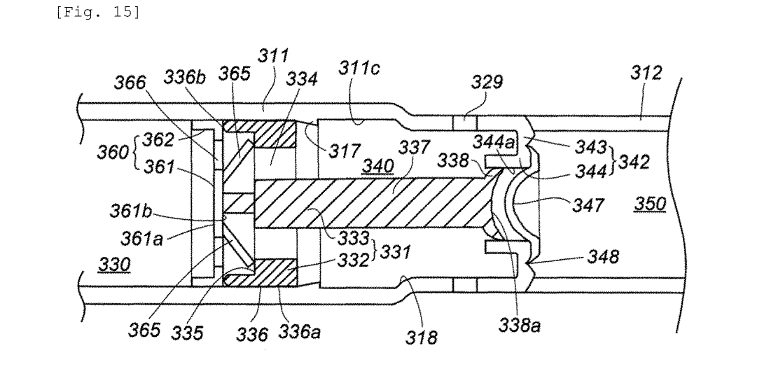

A plurality of gas discharge ports 231 is formed in the diffuser portion 230.

<Gas Generators Shown in FIGS. 13 to 16>

A preferred embodiment of the gas generator shown in FIG. 12 will be described with reference to FIG. 13.

In a gas generator 300 shown in FIG. 13, a combustion chamber 330, a diffuser portion 340, and a pressurized gas chamber 350 are arranged in a cylindrical housing 310.

The cylindrical housing 310 includes a combustion chamber housing 311 and a pressurized gas chamber housing 312, but the entire cylindrical housing may be formed of a single housing.

In the combustion chamber housing 311, an electric igniter 325 is fixed to an opening of a first end portion 311a.

A second end portion 312a of the pressurized gas chamber housing 312 is closed (a closing surface 313).

An opening of a second end portion 311b of the combustion chamber housing 311 and an opening of a first end portion 312b of the pressurized gas chamber housing 312 are welded and integrated at a joining portion 314.

The cylindrical housing 310 (the combustion chamber housing 311 and the pressurized gas chamber housing 312) is made of iron, stainless steel or the like.

A gas such as argon, helium, or the like is filled in the pressurized gas chamber 350 under a high pressure.

The gas is filled from a gas filling hole in the closing surface 313 of the pressurized gas chamber housing 312.

A pin 315 is inserted into the gas filling hole after the gas is filled, and then the pin 315 and the closing surface 313 are welded together to close the gas filling hole.

A second closing device 341 closes between the pressurized gas chamber 350 and the diffuser portion 340.

The second closing device 341 includes a fixing portion 342 and a rupturable plate 347 welded and fixed to the fixing portion 342.

The fixing portion 342 has an annular plate surface 343 extending radially inward from the second end portion 311b of the combustion chamber housing 311, and a cylindrical wall 344 extending from the inner peripheral portion of the annular plate surface 343 toward the diffuser portion 340 (see FIG. 14).

A boundary between the annular plate surface 343 and the cylindrical wall 344 of the fixing portion 342 is a curved surface.

The annular plate surface 343 of the fixing portion 342 has an annular groove 348 in the surface on the side of the pressurized gas chamber 350 (see FIG. 14).

The rupturable plate 347 is made of iron, stainless steel or the like. A periphery of the rupturable plate 347 is abutted against the annular groove 348 formed in the annular plate surface 343 of the fixing portion 342, and in this state, the rupturable plate 347 is welded and fixed at the abutting portion.

At this time, a pressure of the pressurized gas filled in the pressurized gas chamber 350 deforms the rupturable plate 347 toward the diffuser portion 340 along the curved surface of the boundary between the annular plate surface 343 and the cylindrical wall 344. Therefore, concentration of stress on the rupturable plate at the boundary is avoided by the curved surface. As a result, the pressure resistance of the rupturable plate is enhanced.

The diffuser portion 340 is a space into which a gas flows from the pressurized gas chamber 350 and a combustion gas flows from the combustion chamber 330 at the time of actuation.

In FIG. 14, a plurality of gas discharge ports 329 are formed in the combustion chamber housing 311 facing the diffuser portion 340.

The plurality of the gas discharge ports 329 are formed at equal intervals in the circumferential direction of the combustion chamber housing 311.

A known filter can be disposed at a position such as to cover the gas discharge ports 329 of the diffuser portion 340 from the inside.

A breaking device 331 including a base portion 332 and a rod 333 extending from the base portion 332 to the rupturable plate 347 is disposed between the diffuser portion 340 and the combustion chamber 330.

In the breaking device 331 shown in FIGS. 13 to 16, the base portion 332 and the rod 333 are integrated.

The base portion 332 includes a disk portion 335 having a plurality of through holes 334 in the thickness direction and a cylindrical wall surface 336 extending from the outer periphery of the disk portion 335 toward the igniter 325.

An outer circumferential surface 336a of the cylindrical wall surface 336 is abutted against an inner circumferential wall surface 311c of the combustion chamber housing 311 so that the base portion 332 slides in the axis X direction. Since a length of the cylindrical wall surface 336 in the axial direction (the axis X direction) is greater than a thickness of the disk portion 335, the rod 333 does not tilt with respect to the axis X, and the base portion 332 slides parallel to the axis X direction.

A sealant for maintaining airtightness in the combustion chamber 330 is applied between the outer circumferential surface 336a of the cylindrical wall surface 336 and the inner circumferential wall surface 311c of the combustion chamber housing 311.

The rod 333 has a rod main body 337 extending from the base portion 332 and an enlarged diameter portion 338 which is enlarged radially outward from the rod main body 337.

A diameter of the enlarged diameter portion 338 is smaller than the inner diameter of the cylindrical wall 344.

A surface 338a (see FIG. 14) of the enlarged diameter portion 338 of the rod 333 has a shape curved toward the center as shown in FIGS. 13 to 15, but it may be, for example, a rectangular recessed portion.

The breaking device 331 and the second closing device 341 are arranged such that the enlarged diameter portion 338 which is the distal end portion of the rod 333 is surrounded by a cylindrical wall 344 of the fixing portion 342 before actuation. At this time, a slight gap is formed between the outer circumferential portion of the enlarged diameter portion 338 and the inner circumferential surface 344a of the cylindrical wall 344.

A first closing member 360 is disposed at a position in contact with an annular distal end portion 336b of the cylindrical wall surface 336 of the base portion 332.

The first closing member 360 includes a circular main body 361 and an annular wall 362 extending from a peripheral portion of the circular main body 361.

The circular main body 361 has a first surface 361a on the side of the combustion chamber 330 and a second surface 361b on the side of the diffuser portion 340.

A sealant for maintaining airtightness in the combustion chamber 330 is applied between the annular wall 362 and an inner circumferential wall surface 311c of the combustion chamber housing 311.

The first closing member 360 can be the same as the closing member 6 shown in (b) in FIG. 1, or the closing member 70 shown in the plan views of FIGS. 7 to 10.

In the combustion chamber 330, the igniter 325 is fixed to the first end portion 311a, and the opposite side in the axis X direction is partitioned by the base portion 332.

A prescribed amount of gas generating agents 326 is filled in the combustion chamber 330.

A protrusion 317 for restricting movement and a reduced diameter portion 318 for stopping movement are provided, in the order of the above description on the inner circumferential wall surface 311c of the cylindrical housing from the combustion chamber 330 to the diffuser portion 340.

Next, an operation of the gas generator 300 shown in FIG. 13 will be described with reference to FIGS. 13 to 15.

The gas generating agents 326 are ignited and burnt by combustion products generated by the actuation of the igniter 325, and a high-temperature combustion gas is generated.

When a pressure in the combustion chamber 330 is raised by the combustion gas, the fragile portion of the first closing member 360 is ruptured as shown in the cross-sectional views of FIGS. 7 to 10, and the tab 365 is bent from the surface of the non-ruptured portion.

At this time, as shown in FIG. 15, the distal end portion of the bent tab 365 abuts against a surface (a control device) of the base portion 332 having no through holes 334 and the bending is stopped, whereby opening (an opening 366) is restricted to be within the range of the angle (α) of 5 degrees to 85 degrees.

When the combustion gas in the combustion chamber 330 passes through the opening 366 formed in the first closing member 360, the combustion gas necessarily collides with the tab 365. Therefore, mist adheres to the tab 365 and is easily captured thereby.

Where the tab 365 is thus bent to form the opening 366 and the gas is discharged to the diffuser portion 340, the base portion 332 of the breaking device 331 passes over the protrusion 317 and moves while sliding on the inner circumferential wall surface 311c of the combustion chamber housing in the axis X direction. At this time, the first closing member 360 also moves in the axis X direction.

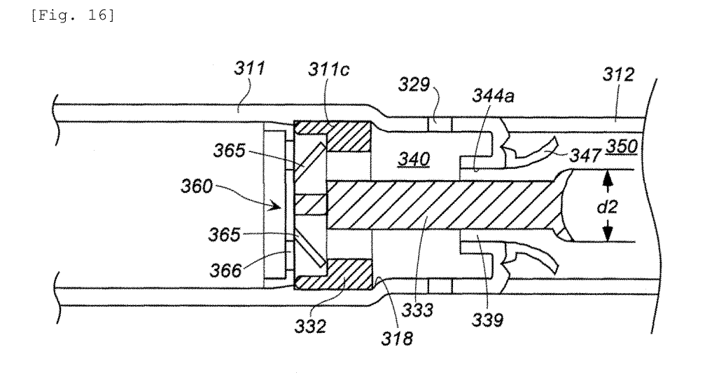

Thereafter, the base portion 332 collides with a stepped portion (the reduced diameter portion) 318 with a reduced internal diameter and stops. By that time, since the enlarged diameter portion 338 of the rod 333 collides with and ruptures the rupturable plate 347, the gas in the pressurized gas chamber 350 flows into the diffuser portion 340 through an annular gap 339 between an opening of the rupturable plate 347 (the inner circumferential surface 344a of the cylindrical wall 344) and the rod main body 337 (FIG. 16).

When the base portion 332 stops, the movement of the first closing member 360 also stops (FIG. 16).

In the state shown in FIG. 16, in the case that, when the gas flows into the diffuser portion 340 from the annular gap 339, the breaking device 331 (the base portion 332) receives pressure, passes over the protrusion 317 and returns toward the combustion chamber 330 and the enlarged diameter portion 338 is located within the inner circumferential surface 344a of the cylindrical wall 344, a cross sectional area of the annular gap 339 changes, and a stable gas flow rate cannot be maintained.

However, since the gas generator 300 has the protrusion 317, as shown in FIGS. 14 to 16, the breaking device 331 (the base portion 332) does not pass over the protrusion 317 and return toward the combustion chamber 330. As a result, the cross-sectional area of the annular gap 339 is kept constant.

Further, since the fixing portion 342 has the cylindrical wall 344, even when a center axis of the rod 333 is displaced when the breaking device 331 (the base portion 332) slides at the time of actuation, the cylindrical wall 344 preferably exerts the guide function, and thereby the rod reliably collides with the rupturable plate 347.

The combustion gas and the pressurized gas flowing into the diffuser portion 340 are discharged from the gas discharge port 329.

Preferred embodiments of the gas generator 300 shown in FIGS. 13 to 16 are described hereinbelow.

(1) A gas generator including the cylindrical housing 310 in which the ignition device (the igniter) 325 is fixed to an opening of the first end portion 311a and the second end portion 312a, on the axially opposite side to the first end portion, is closed,

the combustion chamber 330 provided with the ignition device 325, the diffuser portion 340 provided with the gas discharge port 329 and the pressurized gas chamber 350 being arranged inside the housing in the above described order from the first end portion 311a,

the closing device 341 including the fixing portion 342 and a rupturable plate 347 fixed to the fixing portion 342, the closing device 341 closing between the pressurized gas chamber 350 and the diffuser portion 340,

the breaking device 331 for the rupturable plate 347 including the base portion 332, whose outer circumferential surface is abutted against an inner circumferential wall surface of the cylindrical housing 310, and the rod 333, which extends from the base portion 332 toward the rupturable plate 347, the breaking device 331 being arranged between the combustion chamber 330 and the diffuser potion 340,

the base portion 332 including the disk portion 335 which has a plurality of the through holes 334 in the thickness direction, and the cylindrical wall surface 336 which extends from an outer periphery of the disk portion 335 toward the igniter 325,

the first closing member 360 being disposed at a position such as to abut against the annular distal end portion 336b of the cylindrical wall surface 336 of the base portion 332,

the first closing member 360 including the circular main body 361 and the annular wall 362 which extends from the peripheral end of the circular main body 361,

the circular main body 361 having the first surface 361a on the side of the combustion chamber 330 and the second surface 361b on the side of the diffuser portion 340,

the first closing member 360 having the fragile portion formed such that a part thereof is ruptured when the first surface 361a receives a gas pressure of the combustion gas generated in the combustion chamber 330 and the ruptured portion is bent toward the diffuser portion 340 to be opened,

after the part of the first closing member 360 is ruptured along the fragile portion, the ruptured portion being bent from the surface of the non-ruptured portion and opened so that a gas discharge path to the diffuser portion 340 is opened,

the control device restricting an angle between the second surface 361b of the first closing member 360 and the bent ruptured portion to be 5 degrees to 85 degrees,

the control device being a surface of the disk portion 335 of the base portion 332 in part where no through holes are formed, the control device being adjusted to have such a distance that the bent ruptured portion of the first closing member 360 abuts against the surface of the disk portion 335,

the fixing portion 342 of the closing device 341 including the annular plate surface 343, which extends inward from the inner circumferential wall surface of the cylindrical housing 310 in the radial direction, and the cylindrical wall 344, which extends from the inner periphery of the annular plate surface portion 343 toward the diffuser portion 340,

the rupturable plate 347 of the closing devise 341 being welded and fixed to the annular plate surface 343 of the fixing portion 342 from the pressurized gas chamber 350

the breaking device 331 being disposed such that the distal end portion of the rod 333 is surrounded by the cylindrical wall 344 of the fixing portion 342 of the closing device 341.

(2) The gas generator according to the above (1), wherein

the breaking device includes the base portion 332 and the rod 333 extending from the base portion 332 toward the rupturable plate 347,

the rod 333 has the rod main body 337 extending from the base portion and the enlarged diameter portion 338 in which the distal end portion of the rod main body 337 is enlarged in diameter in the radial direction, and

the enlarged diameter portion 338 is disposed so as to be surrounded by the cylindrical wall 344 of the fixing portion of the closing device 341.

The invention thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A gas generator comprising, in a cylindrical housing, a gas generation chamber accommodating a gas generating agent as a gas generating source and an ignition device,
the ignition device being disposed at a first end surface of the cylindrical housing, and a second end surface, which is axially opposite to the first end surface of the cylindrical housing, being closed by a closing member,
the closing member having a first surface on the side of the gas generation chamber and a second surface on the back side of the first surface,
the closing member having a fragile portion formed such that a part thereof is ruptured when the first surface receives a pressure of a gas including a combustion gas, and the ruptured portion is bent and opened to an axially opposite side of the first surface,
a gas discharge port for the combustion gas being formed by the ruptured portion which is bent and opened from a surface of a non-ruptured portion after the part of the closing member is ruptured along the fragile portion,
a control device restricting an angle between the second surface of the closing member and the bent ruptured portion to be 5 degrees to 85 degrees,
the control device being,
a member which is adjusted to have such a distance that the bent ruptured portion of the closing member is in contact therewith, or
a support portion which is formed to protrude from the second surface of the closing member at a position such as to be in contact with the bent ruptured portion.

2. A gas generator comprising, in a cylindrical housing, a gas generation chamber accommodating a gas generating agent as a gas generating source, and a diffuser portion provided with a gas discharge port,
a closing member closing between the gas generation chamber and the diffuser portion,
the closing member having a first surface on the side of the gas generation chamber and a second surface on the back side of the first surface,
the closing member having a fragile portion formed such that a part thereof is ruptured when the first surface receives a gas pressure from the gas generating source, and the ruptured portion is bent and opened toward the diffuser portion,
a gas discharge path leading to a gas discharge port being opened by the ruptured portion which is bent and opened from a surface of a non-ruptured portion after the part of the closing member is ruptured along the fragile portion,
a control device restricting an angle between the second surface of the closing member and the bent ruptured portion to be 5 degrees to 85 degrees,
the control device being,
a wall surface of the diffuser portion which is adjusted to have such a distance that the bent ruptured portion of the closing member is in contact therewith, or
a support portion which is formed to protrude from the second surface of the closing member at a position such as to be in contact with the bent ruptured portion.

3. The gas generator according to claim 2, wherein the gas generation chamber is a combustion chamber accommodating the gas generating agent and the ignition device,
the part of a closing member is ruptured and opened when the first surface receives the gas pressure of a combustion gas generated in the combustion chamber, so that a combustion gas discharge path leading to the gas discharge port is opened.

4. A gas generator comprising, in a cylindrical housing, a gas generation chamber and a diffuser portion provided with a gas discharge port,
the gas generation chamber being a combination of a combustion chamber accommodating a gas generating agent and an ignition device, and a pressurized gas chamber filled with a gas,
the combustion chamber being arranged on the side of a first end surface of the cylindrical housing, the diffuser portion which is provided with the gas discharge port being arranged on the side of a second end surface which is axially opposite to the first end surface of the cylindrical housing, and the pressurized gas chamber being arranged between the combustion chamber and the diffuser portion,
a first closing member closing between the combustion chamber and the pressurized gas chamber, and a second closing member closing between the pressurized gas chamber and the diffuser portion,
the first closing member having a first surface on the side of the combustion chamber and a second surface on the back side of the first surface, which is on the side of the pressurized gas chamber,
the second closing member having a first surface on the side of the pressurized gas chamber and a second surface on the back side of the first surface, which is on the side of the diffuser portion,
the first closing member having a fragile portion formed such that a part thereof is ruptured when the first surface receives a combustion gas pressure generated in the combustion chamber, and the ruptured portion is bent and opened toward the pressurized gas chamber,
after the part of the first closing member is ruptured along the fragile portion, the ruptured portion being bent from a non-ruptured portion and opened so that a gas discharge path from the combustion chamber to the pressurized gas chamber is opened,
a control device restricting an angle between the second surface of the first closing member and the bent ruptured portion to be 5 degrees to 85 degrees,
the control device being a support portion which is formed to protrude from the second surface of the first closing member at a position such as to be in contact with the bent ruptured portion,
the second closing member having a fragile portion formed such that a part thereof is ruptured when the first surface receives a gas pressure of a combustion gas generated in the combustion chamber and a pressurized gas, and the ruptured portion is bent and opened toward the diffuser portion,
after the part of the second closing member is ruptured along the fragile portion, the ruptured portion being bent from a non-ruptured portion and opened so that a gas discharge path from the pressurized gas chamber to the diffuser portion is opened,
a control device restricting an angle between the second surface of the second closing member and the bent ruptured portion to be 5 degrees to 85 degrees,
the control device being,
a wall surface of the diffuser portion which is adjusted to have such a distance that the bent ruptured portion of the second closing member is in contact therewith, or
a support portion which is formed to protrude from the second surface of the second closing member at a position such as to be in contact with the bent ruptured portion.

5. A gas generator comprising, in a cylindrical housing, a gas generation chamber and a diffuser portion provided with a gas discharge port,
the gas generation chamber being a combination of a combustion chamber accommodating a gas generating agent and an ignition device, and a pressurized gas chamber filled with a gas,
the combustion chamber being arranged on the side of a first end surface of the cylindrical housing, the pressurized gas chamber being arranged on the side of a second end surface which is axially opposite to the first end surface of the cylindrical housing, and the diffuser portion being arranged between the combustion chamber and the pressurized gas chamber,
a first closing member closing between the combustion chamber and the diffuser portion, and a second closing member closing between the diffuser portion and the pressurized gas chamber,
the first closing member having a first surface on the side of the combustion chamber and a second surface on the back side of the first surface, which is on the side of the diffuser portion,
the first closing member having a fragile portion formed such that a part thereof is ruptured when the first surface receives a combustion gas pressure generated in the combustion chamber, and the ruptured portion is bent and opened toward the diffuser portion,
after the part of the first closing member is ruptured along the fragile portion, the ruptured portion being bent from a non-ruptured portion and opened so that a gas discharge path from the combustion chamber to the diffuser portion is opened,
a control device restricting an angle between the second surface of the first closing member and the bent ruptured portion to be 5 degrees to 85 degrees,
the control device being,
a member which is adjusted to have such a distance that the ruptured portion of the first closing member is in contact therewith, or
a support portion which is formed to protrude from the second surface of the first closing member at a position such as to be in contact with the bent portion.
